(19) United States
(12) Patent Application Publication
(10) Pub. No.: US 2007/0200000 A1
(43) Pub. Date: Aug. 30, 2007

(54) Multimedia Gift Card and Total Gift Package

(76) Inventor: James B. Sanders, Amherst, NH (US)

Correspondence Address: ARCHIBALD LLC, 25 MALL ROAD, SUITE 300, BURLINGTON, MA, 01803, US

(21) Appl. No.: 11/621,994

(22) Filed: Jan. 11, 2007

Related U.S. Application Data
(63) Continuation-in-part of application No. 10/660,294, filed on Sep. 11, 2003, now Pat. No. 7,222,797.

(51) Int. Cl. G06K 19/00; G06K 5/00; G06K 7/00

(52) U.S. Cl. 235/487; 235/486; 235/380

(57) ABSTRACT

Provided is a total gift package for promotional and/or entertainment media and the like along with transactional media items as desired. Various configurations of the above mentioned media and entertainment and promotional items may be packaged with an informational wrap sheet and a transactional media item along with a multimedia gift card. The entire assembly may be packaged so that point of purchase transactions can be conducted without opening or otherwise disturbing the package or its contents.

### CROSS-REFERENCE TO RELATED APPLICATIONS

This is a continuation in part of application Ser. No. 10/660,294 filed Sep. 11, 2003 entitled MULTIMEDIA GIFT CARD. application Ser. No. 10/660,294 is hereby incorporated herein by reference in its entirety.

### BACKGROUND OF THE INVENTION

1. Field of the Invention

This invention relates generally to the field of cards and promotional materials and more particularly to a multimedia gift card and total gift package.

2. Description of the Related Art

Music recorded on all types of medium has been sold and given as gifts for many years. Seasonal and non-seasonal gift cards have also been a primary means to express sentiment and celebrate a multitude of events. Corporations and businesses have often given small gifts to employees, sales staff and customers which include pens, cups, glasses, bumper stickers, hats, and shirts, usually displaying the company colors, logos, and information. All of these items, when given, are perceived as gifts to the receiver, however; also have immense promotional value for the provider. Retailers often provide gift certificates for purchase that are usually in the form of a plastic credit card. These gift certificates are usually not packaged to be given as a gift. Most gift cards hang from a piece of cardboard on a display rack previously sold with a single piece of cardboard which sometimes could be folded into a simple card. Retailers relied on displaying individual gift certificates from a single piece of cardboard, paper or plastic. The purchaser in most cases would have to purchase an additional card to send or give the certificate, coupon or prepaid phone card as a gift. The advent and mass production of the personal computer, reduction in system cost, and increased popularity and accessibility to the internet, has enabled most consumers to own or have access to a computer. The exponential growth and availability of digital quality audio, video and graphics accompanied by the many compression formats and increased storage capacity of digital medium has provided a unique and diverse avenue for promotion by corporations, business, brokers, retailers, and universities.

Although there exists prior art that attempts to efficiently employ the various aspects of media and media presentation and transference, none of the prior art inventions include the novel aspects of the present invention.

### BRIEF SUMMARY OF THE INVENTION

The present invention comprises a Total Gift Package that is versatile and customizable to fit the needs of any consumer. It may be purchased via normal retail means, or via the internet through a unique purchasing system. The arrangement and construction of the present invention provides for the inclusion of any form of digital and/or transactional media in a single package.

### BRIEF DESCRIPTION OF THE SEVERAL VIEWS OF THE DRAWINGS

These and other features, aspects and advantages of the present invention will become better understood with reference to the following description, appended claims, and accompanying drawings where:

FIG. 1 illustrates an embodiment of a Multi-media Gift Card.

FIG. 1a illustrates an embodiment of a single fold Multimedia Gift Card assembly.

FIG. 1b illustrates an embodiment of a Multimedia Gift Card containing Digital and Transactional Media.

FIG. 2 illustrates an alternate embodiment of a Multi-media Gift Card.

FIG. 2a illustrates an example of a single fold Multimedia Gift Card assembly with Transactional media affixed.

FIG. 2b illustrates an example of a Multimedia Gift Card containing Digital and Transactional Media.

FIG. 3 illustrates an alternate embodiment of a Multi-media Gift Card.

FIG. 3a illustrates an example of a single fold Multimedia Gift Card assembly.

FIG. 3b illustrates an example of a single fold Multimedia Gift Card assembly containing a single Digital media item.

FIG. 4 illustrates an example of a single fold Multimedia Gift Card assembly with a media holding device attached.

FIG. 4a illustrates an example of a single fold Multimedia Gift Card assembly containing a single Digital media item and media holding device.

FIG. 5 illustrates an alternate embodiment of a Multi-media Gift Card.

FIG. 5a illustrates an example of a single fold Multimedia Gift Card assembly.

FIG. 5b illustrates an example of a Multimedia Gift Card containing two types of Digital Media items.

FIG. 6 illustrates an alternate embodiment of a Multi-media Gift Card.

FIG. 6a illustrates an example of a single fold Multimedia Gift Card assembly.

FIG. 6b illustrates an example of a Total Gift Package comprising a Multimedia Gift Card containing a variety of Digital and Transactional Media items.

FIG. 7 illustrates an alternate embodiment of a Multi-media Gift Card.

FIG. 7a illustrates an example of a single fold Multimedia Gift Card assembly.

FIG. 7b illustrates an example of a Total Gift Package comprising a Multimedia Gift Card containing a Digital Media item and an additional Transactional Media or Digital Media affixed to the Multimedia Gift Card.

FIG. 8 illustrates an example a single fold Multimedia Gift Card assembly with a media holding device attached.

FIG. 8a illustrates an example of a single fold Multimedia Gift Card assembly containing Digital media item that is attached by a media holding device and an additional Digital media or Transactional Media item.

FIG. 9 illustrates an example of a single fold Multimedia Gift Card assembly with a media holding device attached.

FIG. 9a illustrates an example of a single fold Multimedia Gift Card assembly containing a Digital media item that is attached by holding device and an attached Transactional Media item.

FIG. 10 illustrates an example of a single fold Multimedia Gift Card assembly with two media holding devices attached.

FIG. 10a illustrates an example of a single fold Multimedia Gift Card assembly containing Digital media that is attached by media holding devices and an attached Transactional Media item.

FIG. 11 illustrates an alternate embodiment of a Multi-media Gift Card.

FIG. 11a illustrates an example a single fold Multimedia Gift Card assembly that includes a window.

FIG. 11b illustrates an alternate embodiment of a Total Gift Package comprising a Multimedia Gift Card containing Digital and Transactional Media.

FIG. 11c illustrates a back view of a Multimedia Gift Card displaying access to Transactional Media through access window.

FIG. 12 illustrates an example of a Multi-media Gift Card.

FIG. 12a illustrates an example of a single fold Multimedia Gift Card assembly and window

FIG. 12b illustrates an alternate embodiment of a Total Gift Package comprising a Multimedia Gift Card containing Digital and Transactional Media items and window.

FIG. 12c illustrates a back view of a Multimedia Gift Card and a window.

FIG. 13 illustrates an example of a Multi-media Gift Card.

FIG. 13a illustrates an alternate embodiment of a Total Gift Package comprising a Multimedia Gift Card containing Digital and Transactional Media and window.

FIG. 13b illustrates a back view of a Multimedia Gift Card and a window.

FIG. 14 illustrates an example of a Multi-media Gift Card.

FIG. 14a illustrates an example of a single fold Multimedia Gift Card assembly that can receive only one Digital media item and an attached transactional media item.

FIG. 14b illustrates an example of a single fold Multimedia Gift Card assembly containing only one Digital media item C and an attached transactional media item.

FIG. 14c illustrates a back view of a Multimedia Gift Card displaying an attached transactional media item.

FIG. 15 illustrates an alternate embodiment of a Multi-media Gift Card.

FIG. 15a illustrates a front view of a Multimedia Gift Card displaying Digital Media attached to holding device.

FIG. 15b illustrates a back view of a Multimedia Gift Card displaying attached transactional media item.

FIG. 16 illustrates an alternate embodiment of a Multimedia Gift Card.

FIG. 16a illustrates an example of a single fold Multimedia Gift Card assembly that can receive only one Digital media item and a detachable Transactional Media item.

FIG. 16b illustrates an example of a single fold Multimedia Gift Card assembly containing only one Digital media item and a detachable Transactional Media item.

FIG. 16c illustrates a back view of a Multimedia Gift Card displaying detachable Transactional Media item.

FIG. 17 illustrates an alternate embodiment of a Multi-media Gift Card.

FIG. 17a illustrates an example of a single fold Multimedia Gift Card assembly that can receive only one Digital media item and a detachable Transactional Media item.

FIG. 17b illustrates an example of a single fold Multimedia Gift Card assembly containing only one Digital media item and a detachable Transactional Media item.

FIG. 17c illustrates a back view of a Multimedia Gift Card displaying detachable Transactional Media item.

FIG. 18 illustrates an alternate embodiment of a Multi-media Gift Card.

FIG. 18a illustrates an example a single fold Multimedia Gift Card assembly.

FIG. 18b illustrates an alternate embodiment of a Total Gift Package comprising a Multimedia Gift Card containing Digital and Transactional Media Total Gift Package.

FIG. 19 illustrates an alternate embodiment of a Multi-media Gift Card.

FIG. 19a illustrates an example of a single fold Multimedia Gift Card assembly.

FIG. 19b illustrates an embodiment of a Total Gift Package comprising a Multimedia Gift Card containing Digital and Transactional Media items.

FIG. 20 illustrates an example of a Transactional media holder.

FIG. 20a illustrates an example of a Transactional media holder with Transactional Media attached.

FIG. 20b illustrates an example of an attached Transactional Media item.

FIG. 21 illustrates an example of an Informational wrap sheet.

FIG. 21a illustrates an example of a Multimedia Gift Card envelope

FIG. 21b illustrates an example of a Multimedia Gift Card.

FIG. 21c illustrates an alternate embodiment of a Transactional media holder.

FIG. 21d illustrates a side view of a Total Gift Package for retail display.

FIG. 21e illustrates an expanded side view of Total Gift Package for retail display.

FIG. 22 illustrates a front view of Total Gift Package for retail point of purchase for display or hanging.

FIG. 22a illustrates a back view of Total Gift Package for retail point of purchase for display or hanging.

FIG. 23 illustrates an example of a Transactional media holder.

FIG. 23a illustrates an example of a Transactional media holder and attached Transactional Media.

FIG. 23b illustrates an example of the Transactional media holder and attached Multimedia Gift Card.

FIG. 24 illustrates an example of an Informational Wrap Sheet.

FIG. 24a illustrates an embodiment of an assembled Total Gift Package.

FIG. 24b illustrates an expanded view of the assembled Total Gift Package.

FIG. 25 illustrates an informational wrap sheet that allows the Multi-media Gift Card to be viewed through the front of the Gift Package.

FIG. 25a illustrates a Multimedia Gift Card envelope.

FIG. 25b illustrates the Multimedia Gift Card as a component part of the Total Gift Package.

FIG. 25c illustrates an expanded view of an assembled Total Gift Package.

FIG. 25d illustrates a side view of a Total Gift Package.

FIG. 26 illustrates a Total Gift Package for retail point of purchase display hanging with Multi-media Gift Card.

FIG. 27 depicts a method for an Internet ordering process for the Multi-media Gift Card and Total Gift Package.

### DETAILED DESCRIPTION OF THE INVENTION

For ease of reference the following key may be used to identify various components and other features of the present invention throughout the many figures:
A. The Multi-media Gift Card enclosure (Folder/Greeting Card) material is media that can include but is not limited to various weights of paper, cardboard, synthetics, mixed composites, and plastics. Inks, Dies, Graphics, Indicia, and or attached media can be applied to enclosure for visual appeal.
The Enclosure can be die cut, scored, adhesive applied, and folded to create pockets, tabs, sleeves and holder which can be used to receive, display, and hold additional components to include digital and transactional media, promotional coupons, and booklets. Holders can also be applied to receive or affix additional components to the enclosure that include foam or other material, CD/DVD buttons, hubs, dots, spots, and adhesive discs.
B. Adhesive or other bonding agent or process is applied to bind tow panels to form pockets, sleeves, tabs or holder to which can receive, display and hold digital and transactional media.
C. Large die-cut which can be used after folding and bonding agent application to create a pocket, tab, sleeve or holder that can be used to receive, display, and hold additional components to include digital and transactional media, promotional coupons, and booklets.
D. Smaller die-cut which can be used after folding and bonding agent application to create a pocket, tab, sleeve or holder that can be used to receive, display, and hold additional components to include digital and transactional media, smaller storage media, promotional coupons, and booklets.
E. Multimedia Gift Card—A greeting card or folder that is designed and manufactured to hold digital and or transactional media. These additional components combined with the Multimedia Gift Card create the Total Gift Package.
The Total Gift Package—any combination of digital and or transactional media inserted or attached to the Multimedia Gift Card by adhesive or other bonding agents, pockets, sleeves, tabs or additional holders to include foam digital media disc and any other additional components to enhance the functionality and gift giving experience. These additional components can include but are not limited to envelopes, informational wrap sheets, Transactional and or Digital media, shrink wrap, or other forms of packaging.
F. Digital Media is defined as any form of media that can store and or transfer digital information to include CD, DVD, mini discs, and memory cards.
G. Transactional media—Any media that can be used to transfer or store data. This data can be used to complete or transfer information/data to include purchases and promotion. Examples include but are not limited to credit cards, stored value cards, hotel room keys, memory cards, smart cards, magnetic, scan-able to include bar codes, optical radio-transponder or digital method of completing a transaction. Transactional media also refers to any media that has memory storage to include data transfer capabilities and is not limited to SD and USB memory cards.
H. Additional holders to include foam, plastic, and other composite materials that can be used to secure and display digital or transactional media.
I. Windows, openings, or access panels, that can be used to access enclosed transactional media.
J. Attached transactional media to include magnetic stripe, bar code, or any other transactional method, media, or indicia.
K. Transactional media holder to allow access to transactional media without removing from secure packaging to include shrink wrap.
L. Die Cuts or tabs to hold transactional media in place.
M. Hang hole for display mounting.
N. Informational Wrap Sheet top fold.
O. Informational Wrap Sheet bottom fold. Used to hold components above digital media for easy access.
P. Informational wrap sheet. Used to securely hold Total Gift Package components to include Multimedia Gift Card and envelope in place to allow easy access to transactional media. It is also used to display information regarding the Total Gift Package, its components, and any other information and indicia.
Q. Multimedia Gift Card envelope.
R. Transactional media holder that can be inserted into die-cut holder and or affixed with bonding agent to allow access to transactional media without removing from secure packaging to include shrink wrap.
S. Informational Wrap Sheet which is made from a more rigid material to include heavy weight paper or light weight card board. The Transactional media is attached by holders or a bonding agent.
T. Top fold of the Informational Wrap Sheet S.
U. Informational wrap sheet that allows the Multi-media Gift Card to be viewed through the front of the Gift Package.
V. Top Fold line of Informational Wrap Sheet U.
W. Stiffener Material to include Chip Board, Plastic, SBS, Light Card Board.

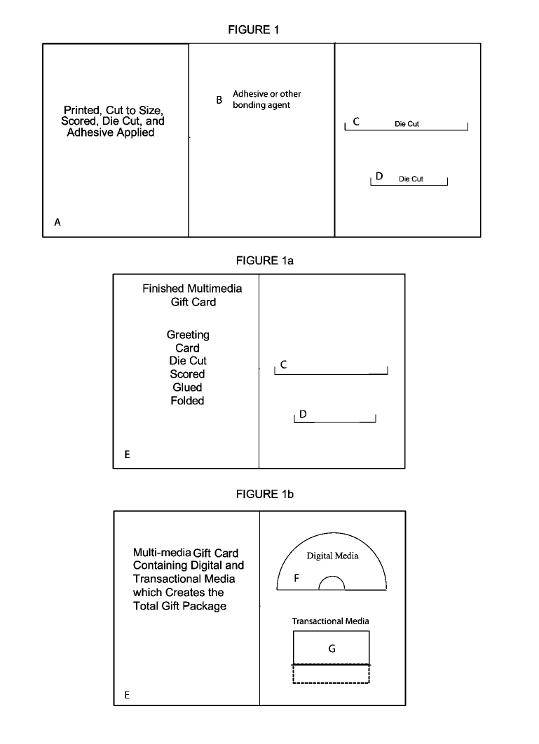

FIGS. 1-1c illustrates an embodiment of the present invention. FIG. 1 depicts an example of a Multimedia Gift Card produced by a particular method of production. Graphics, inks, dies and or indicia are placed on a card material that may include paper and similar materials. The card material is then die cut and scored along fold lines. The right hand panel that displays the die cuts C and D is folded towards the center panel and attached with adhesive B in a way to allow die cut slots C and D to receive and hold media components or other desired items. FIG. 1a illustrates the multimedia gift card of FIG. 1 after it has been properly assembled. FIG. 1b includes the addition of a digital media item F and a Transactional Media G. Digital Media or digital media item is defined as any form of media that can store and or transfer digital information to include CD, DVD, mini discs, machine readable items, and memory cards. Transactional media or transactional media item includes any media that can be used to transfer or store data. This data can be used to complete or transfer information/data to include purchases and promotion. Examples include, but are not limited to credit cards, stored value cards, hotel room keys, memory cards, smart cards, magnetic, scan-able to include bar codes, optical radio-transponder or digital method of completing a transaction. Transactional media also refers to any media that has memory storage to include data transfer capabilities and may also include, but is not limited to SD and USB memory cards. The multimedia gift card containing digital media F and transactional media G creates one embodiment of the present invention, the Total Gift Package.

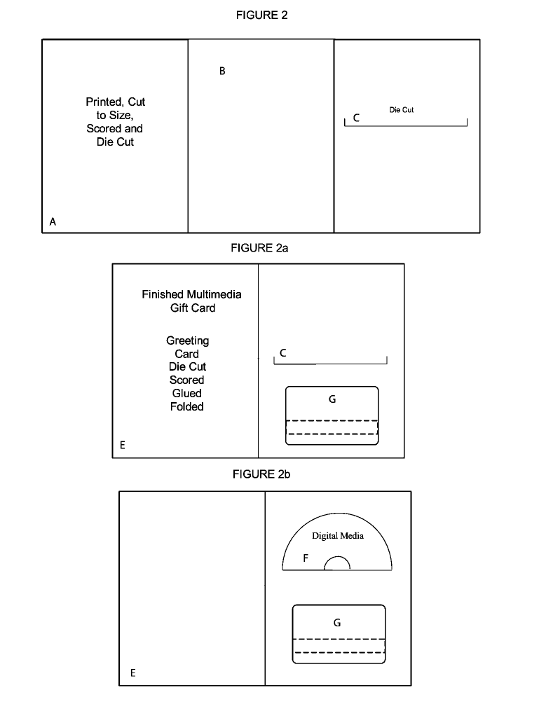

FIGS. 2-2b illustrate another embodiment of the present invention. Graphics, inks, dies and or indicia are placed on a card material. The card material is then die cut and scored along fold lines. The right hand panel that displays the die cut C is folded towards the center panel and attached with adhesive in a way to allow a die cut slot C to receive and hold media components. FIG. 2a illustrates the multimedia gift card assembly with Transactional media affixed to Multimedia Gift Card with adhesive, tabs, or holders. FIG. 2b illustrates the finished assembly comprising a Multimedia Gift Card containing Digital and Transactional Media inserted into a die-cut slot creating a sleeve to hold media and the Transactional Media affixed with adhesive creating a Total Gift Package.

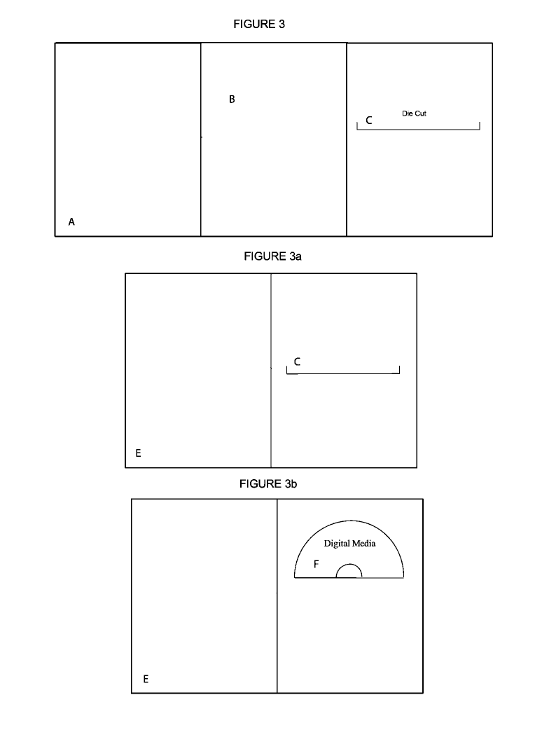

FIGS. 3-3b illustrate an embodiment of the total gift package wherein the right hand panel of the multimedia gift card that display the die cut C is folded towards the center panel and attached with adhesive in a way to allow a die cut slot C to receive and hold media components. FIG. 3b shows the completed assembly with only a single digital media F.

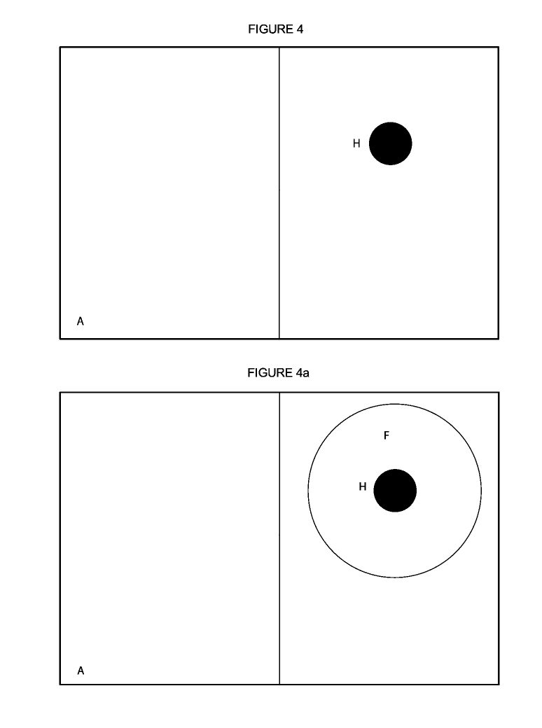

FIGS. 4-4a illustrate an example of a single fold Multimedia Gift Card assembly with a media holding device attached. FIG. 4a illustrates the Multimedia Gift Card assembly containing a single Digital media that is attached by a media holding device.

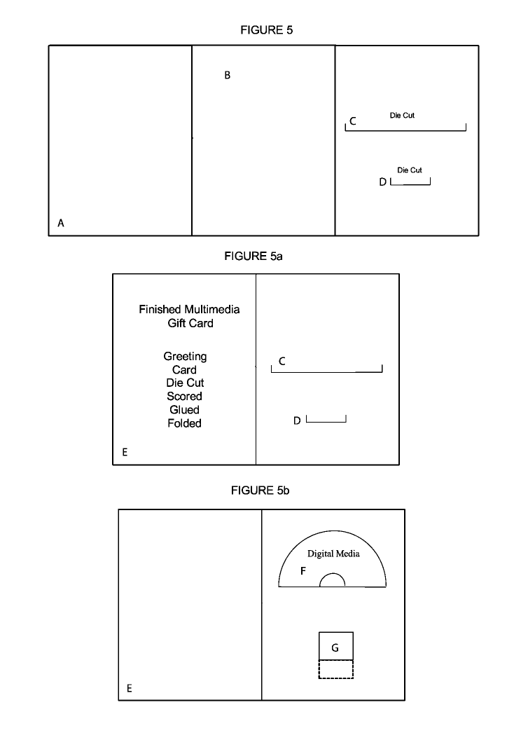

FIGS. 5-5c illustrate another embodiment of the present invention. FIG. 5 depicts an example of a method of production of a Multi-media Gift Card. Graphics, inks, dies and or indicia are placed on card material. The material is then die cut and scored along fold lines. The right hand panel that display the die cuts C and D is folded towards center panel and attached with adhesive in a way to allow die cut slots C and D to receive and hold media components. FIG. 5b illustrates an example of the assembled total gift package comprising a Multimedia Gift Card containing 2 types of Digital Media that are inserted into die-cut slots creating sleeves to hold the media.

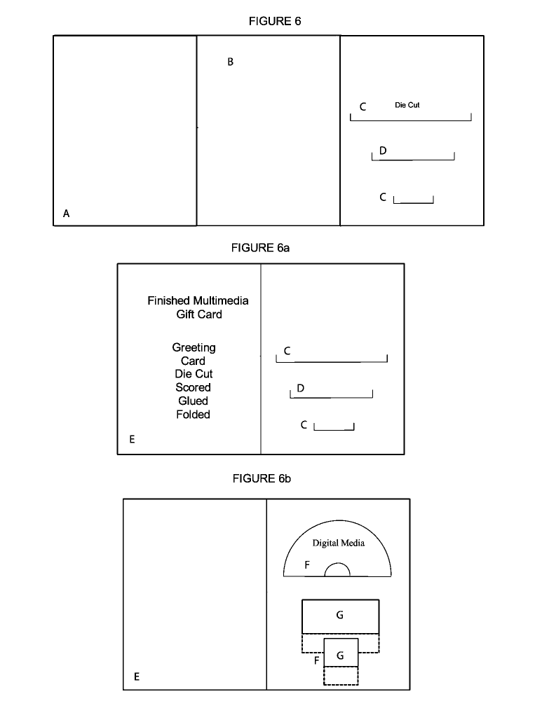

FIGS. 6-6b illustrate another embodiment of the present invention. FIG. 6 depicts an example of a method of production of a Multi-media Gift Card. Graphics, inks, dies and or indicia are placed on card material. The card material is then die cut and scored along fold lines. The right hand panel that displays the die cuts C and D is folded towards center panel and attached with adhesive in a way to allow die cut slots C and D to receive and hold media components. FIG. 6b depicts the assembled total gift package comprising a Multimedia Gift Card containing a variety of Digital and Transactional Media inserted into a die-cut slot creating sleeves to hold media.

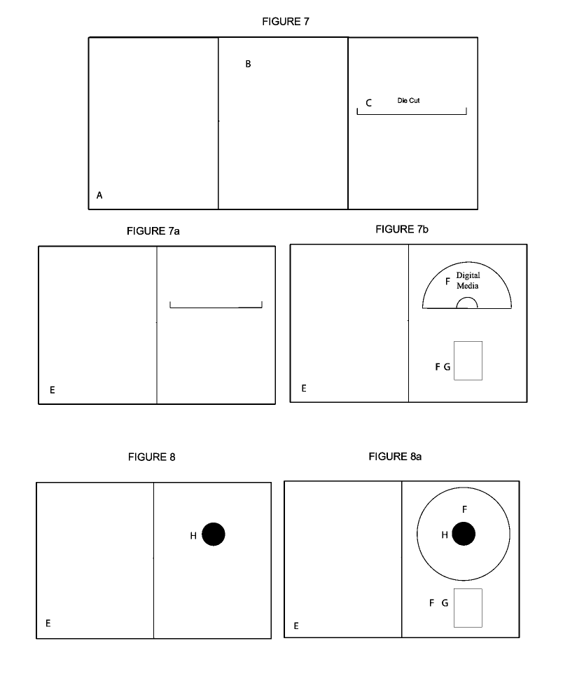

FIGS. 7-7b illustrate another embodiment of the present invention. FIG. 7 illustrates an example of a method of production of a Multi-media Gift Card. Graphics, inks, dies and or indicia are placed on card material. The card material is then die cut and scored along fold lines. The right hand panel that display the die cut C is folded towards center panel and attached with adhesive in a way to allow a die cut slot C to receive and hold media components. FIG. 7b depicts the assembled total gift package comprising a Multimedia Gift Card containing Digital Media inserted into a die-cut slot creating a sleeve to hold the media. An additional Transactional Media or Digital Media is affixed with adhesive creating the Total Gift Package.

FIGS. 8-8a illustrate another embodiment of the present invention. FIG. 8 illustrates an example of a single fold Multimedia Gift Card assembly with a media holding device attached. FIG. 8a depicts an example of a single fold Multimedia Gift Card assembly containing Digital media that is attached by holding device and an additional Digital media or Transactional Media attached with adhesive.

FIGS. 9-9a illustrate another embodiment of the present invention. FIG. 9 depicts an example of a single fold Multimedia Gift Card assembly with a media holding device attached. FIG. 9a illustrates an example of a single fold Multimedia Gift Card assembly containing Digital media that is attached by the media holding device and Transactional Media attached with adhesive.

FIGS. 10-10a illustrate another embodiment of the present invention. FIG. 10 depicts an example of a single fold Multimedia Gift Card assembly with two media holding devices attached. FIG. 10a depicts an example of a single fold Multimedia Gift Card assembly containing Digital media that is attached by holding devices and a Transactional Media attached with adhesive.

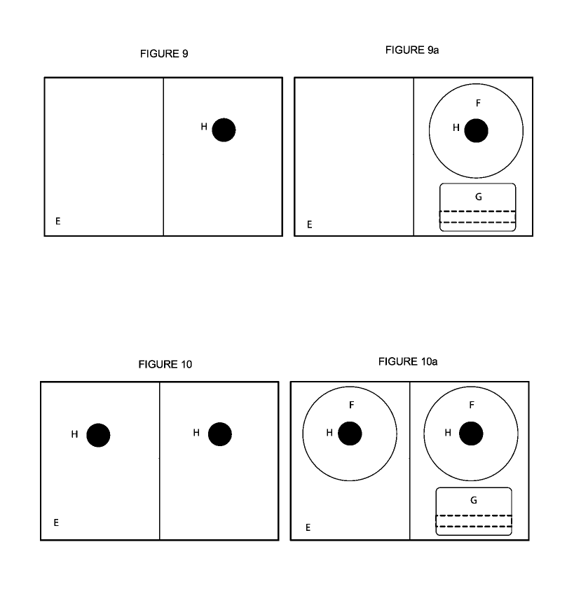

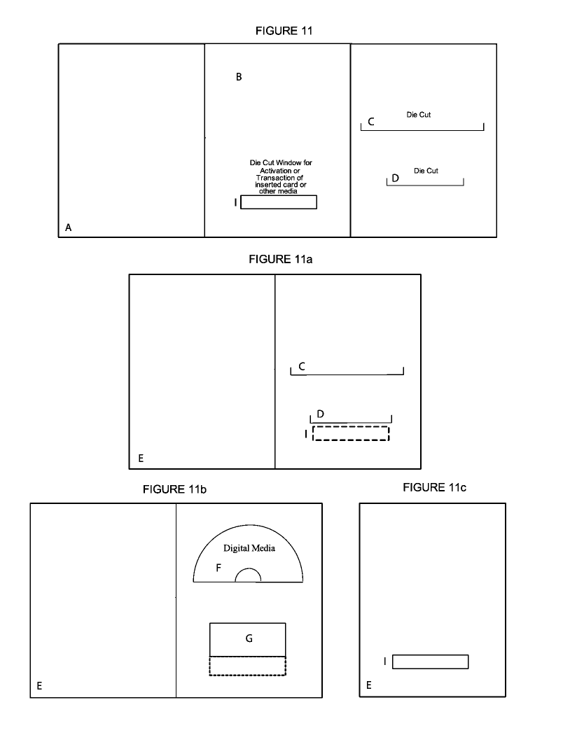

FIGS. 11-11c illustrate another embodiment of the present invention. FIG. 11 depicts an example of a method of production of a Multi-media Gift Card. Graphics, inks, dies and or indicia are placed on card material. The card material is then die cut and scored along fold lines. Windows, openings, or access panels, are created that can be used to access enclosed transactional media. The right hand panel that display the die cuts C and D is folded towards center panel and attached with adhesive in a way to allow die cut slots C and D to receive and hold media components. FIG. 11b depicts an example of a Multimedia Gift Card containing Digital and Transactional Media inserted into die-cut slots creating sleeves to hold media creating a Total Gift Package. Transactional Media can be accessed through window I. FIG. 11c depicts the back of the Multimedia Gift Card displaying access to Transactional Media through access window.

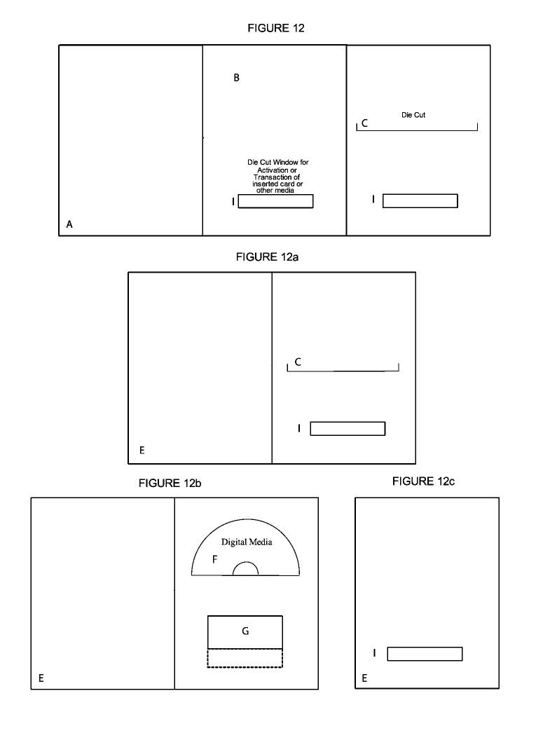

FIGS. 12-12c illustrate another embodiment of the present invention. FIG. 12 depicts an example of a method of production of a Multi-media Gift Card. Graphics, inks, dies and or indicia are placed on card material. The card material is then die cut and scored along fold lines. Windows, openings, or access panels, are created that can be used to access enclosed transactional media. The right hand panel that display the die cut C is folded towards center panel and attached with adhesive in a way to allow die cut slot C to receive and hold media components. FIG. 12b depicts an example of a Multimedia Gift Card containing Digital and Transactional Media inserted into a die-cut slot creating a sleeve to hold media and the Transactional Media affixed with adhesive creating a Total Gift Package. Transactional Media can be accessed through window I. FIG. 12c depicts the back of the Multimedia Gift Card displaying access to Transactional Media through access window I.

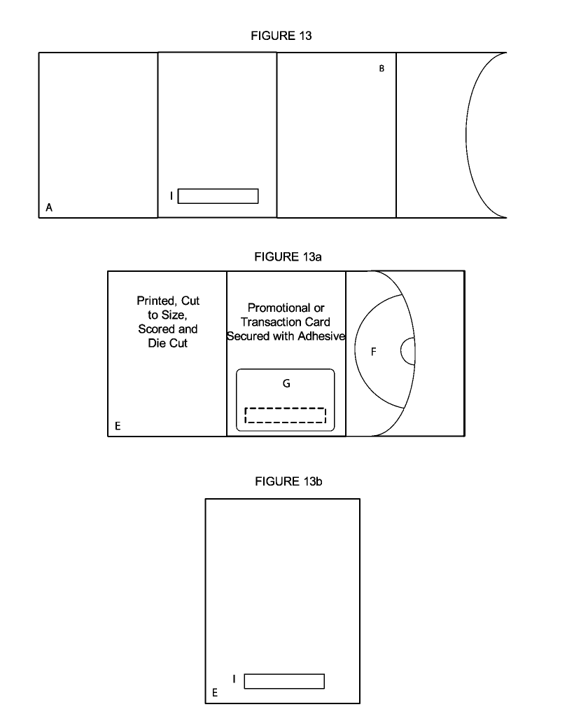

FIGS. 13-13b illustrate another embodiment of the present invention.

FIG. 13 depicts an example of a method of production of a Multimedia Gift Card. Graphics, inks, dies and or indicia are placed on card material. The card material is then die cut and scored along fold lines. Windows, openings, or access panels, are created that can be used to access enclosed transactional media. The right hand panel is folded towards center panel and attached with adhesive in a way to allow a pocket or sleeve to be created which will receive and hold media components. FIG. 13a shows an example of a Multimedia Gift Card containing Digital and Transactional Media inserted into sleeve and the Transactional Media affixed with adhesive creating a Total Gift Package. Transactional Media can be accessed through window I. FIG. 13b shows a back view of a Multimedia Gift Card displaying access to Transactional Media through access window I.

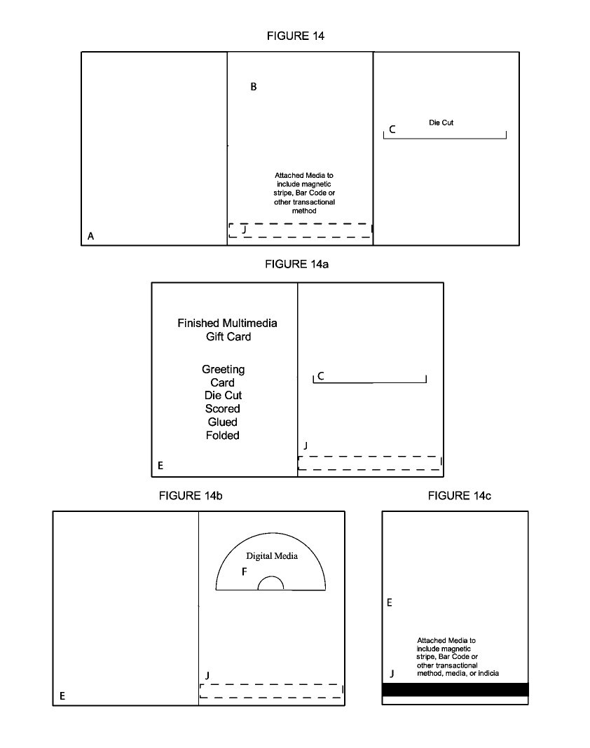

FIGS. 14-14c illustrate another embodiment of the present invention. FIGS. 14 depicts an example of a method of production of a Multi-media Gift Card. Graphics, inks, dies and or indicia are placed on card material. Attached transactional media to include magnetic stripe, bar code, or any other transactional method, media, or indicia is applied. The material is then die cut and scored along fold lines. The right hand panel that display the die cut C is folded towards center panel and attached with adhesive in a way to allow a die cut slot C to receive and hold media components. FIG. 14a then shows an example of a single fold Multimedia Gift Card assembly that can receive only one Digital media item that is inserted in a die-cut slot C and has attached transactional media to include magnetic stripe, bar code, or any other transactional method, media, or indicia. FIG. 14b shows an example of a single fold Multimedia Gift Card assembly containing only one Digital media item that is inserted in a die-cut slot C and has attached transactional media to include magnetic stripe, bar code, or any other transactional method, media, or indicia. FIG. 14c depicts a back view of a Multimedia Gift Card displaying attached transactional media to include magnetic stripe, bar code, or any other transactional method, media, or indicia

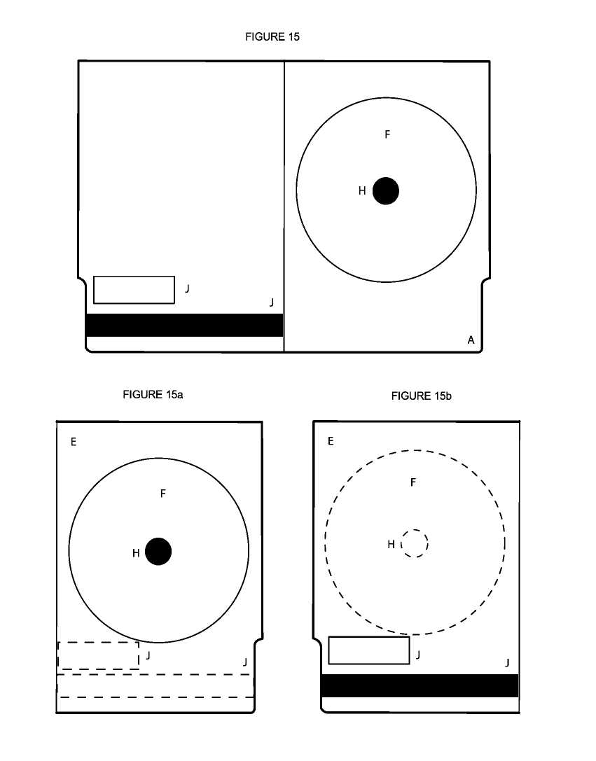

FIGS. 15-15b illustrate another embodiment of the present invention. FIG. 15 shows an example of a method of production of a Multi-media Gift Card. Graphics, inks, dies and or indicia are placed on card material. Attached transactional media to include magnetic stripe, bar code, or any other transactional method, media, or indicia is applied. The card material is then die cut and scored along fold lines. A media holding device is attached to receive and hold Digital Media. FIG. 15a shows a front view of a Multimedia Gift Card displaying Digital Media attached to holding device. FIG. 15b shows a back view of a Multimedia Gift Card displaying attached transactional media to include magnetic stripe, bar code, or any other transactional method, media, or indicia.

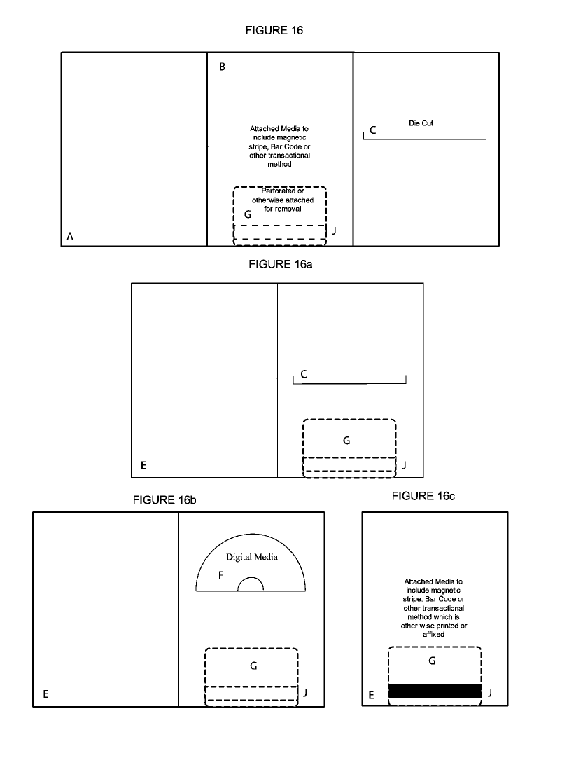

FIGS. 16-16c illustrate another embodiment of the present invention. FIG. 16 shows an example of a method of production of a Multi-media Gift Card. Graphics, inks, dies and or indicia are placed on card material. Attached transactional media to include magnetic stripe, bar code, or any other transactional method, media, or indicia is applied. The material is then die cut and scored along fold lines. The right hand panel that display the die cut C is folded towards center panel and attached with adhesive in a way to allow a die cut slot C to receive and hold media components. Attached transactional media to include magnetic stripe, bar code, or any other transactional method, media, or indicia is applied to detachable Transactional Media. Perforations can assist in detaching the detachable Transactional Media. FIG. 16a then shows an example of a single fold Multimedia Gift Card assembly that can receive only one Digital media item that is inserted in a die-cut slot C and has a detachable form of Transactional Media to include magnetic stripe, bar code, or any other transactional method, media, or indicia. FIG. 16b shows an example of a single fold Multimedia Gift Card assembly containing only one Digital media item that is inserted in a die-cut slot C and has detachable Transactional Media to include magnetic stripe, bar code, or any other transactional method, media, or indicia. FIG. 16c shows a back view of a Multimedia Gift Card displaying detachable Transactional Media to include magnetic stripe, bar code, or any other transactional method, media, or indicia.

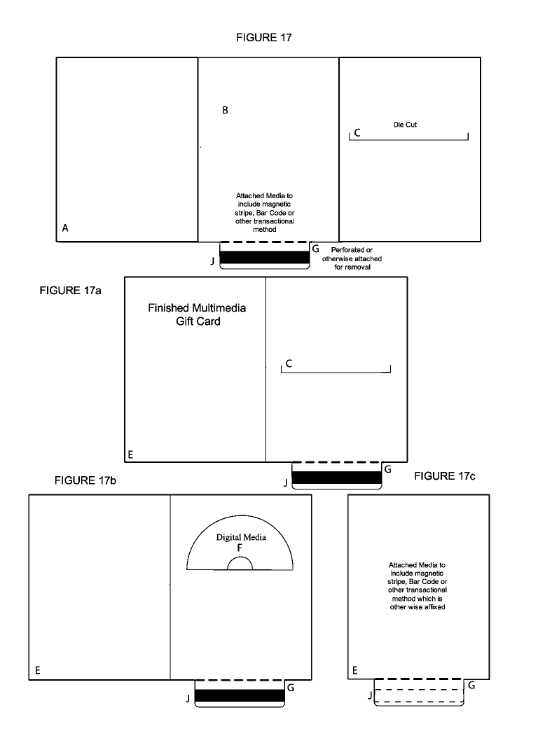

FIGS. 17-17c illustrate another embodiment of the present invention. FIG. 17 shows an example of a method of production of a Multi-media Gift Card. Graphics, inks, dies and or indicia are placed on card material. Attached transactional media to include magnetic stripe, bar code, or any other transactional method, media, or indicia is applied. The card material is then die cut and scored along fold lines. The right hand panel that display the die cut C is folded towards center panel and attached with adhesive in a way to allow a die cut slot C to receive and hold media components. Attached transactional media to include magnetic stripe, bar code, or any other transactional method, media, or indicia is applied to detachable Transactional Media. Perforations can assist in detaching the detachable Transactional Media. FIG. 17a shows an example of a single fold Multimedia Gift Card assembly that can receive only one Digital media item that is inserted in a die-cut slot C and has a detachable form of Transactional Media to include magnetic stripe, bar code, or any other transactional method, media, or indicia. FIG. 17b shows an example of a single fold Multimedia Gift Card assembly containing only one Digital media item that is inserted in a die-cut slot C and has detachable Transactional Media to include magnetic stripe, bar code, or any other transactional method, media, or indicia. FIG. 17c shows a back view of a Multimedia Gift Card displaying detachable Transactional Media to include magnetic stripe, bar code, or any other transactional method, media, or indicia.

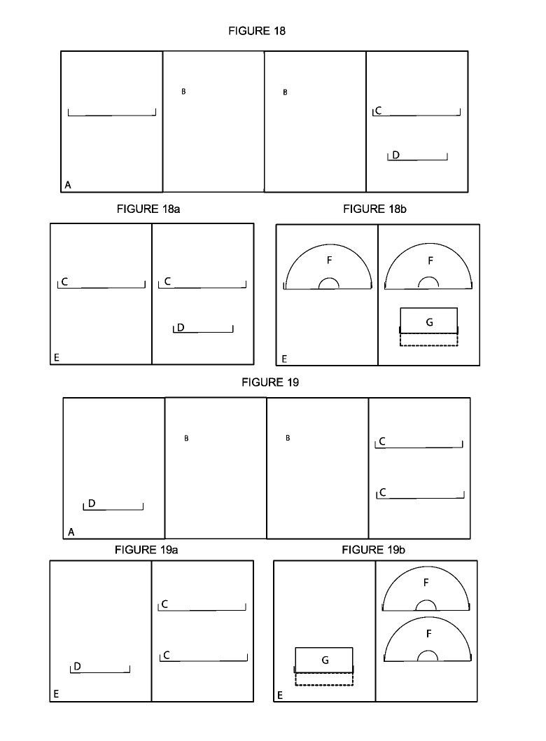

FIGS. 18-18b illustrate another embodiment of the present invention. FIG. 18 shows an example of a method of production of a Multi-media Gift Card. Graphics, inks, dies and or indicia are placed on material to include paper. The material is then die cut and scored along fold lines. The right hand panel that display the die cuts C and D is folded towards the center panel and attached with adhesive in a way to allow die cut slots C and D to receive and hold media components. The left panel is also folded towards the center panel and attached with adhesive in a way to allow the die cut slot to receive and hold a digital media a component. FIG. 18a shows an example a single fold Multimedia Gift Card assembly. FIG. 18b shows an example of a Multimedia Gift Card containing Digital and Transactional Media inserted into die-cut slots creating sleeves to hold media creating a Total Gift Package.

FIGS. 19-19b illustrate another embodiment of the present invention. FIG. 19 shows an example of a method of production of a Multi-media Gift Card. Graphics, inks, dies and or indicia are placed on card material. The card material is then die cut and scored along fold lines. The right hand panel that display the die cuts C and D is folded towards the center panel and attached with adhesive in a way to allow die cut slots C and D to receive and hold media components. The left panel is also folded towards the center panel and attached with adhesive in a way to allow the die cut slot to receive and hold a digital media a component. FIG. 19a displays an example of a single fold Multimedia Gift Card assembly; and FIG. 19b shows an example of a Multimedia Gift Card containing Digital and Transactional Media inserted into die-cut slots creating sleeves to hold media creating a Total Gift Package.

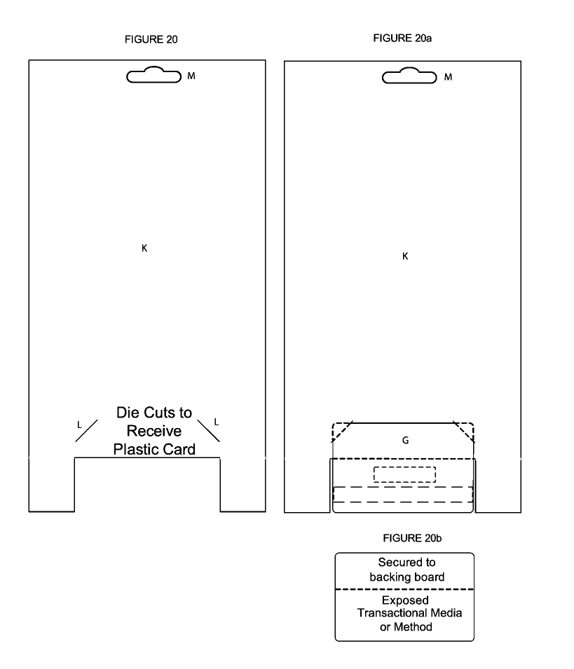

FIGS. 20-20b illustrate another embodiment of the present invention. FIG. 20 shows a transactional media holder that may be employed to allow access to transactional media without removing from secure packaging to include shrink wrap. FIG. 20a displays a transactional media holder with Transactional Media attached. FIG. 20b is an illustration of the attached Transactional Media also depicting the ability to utilize the exposed portion while securely packaged.

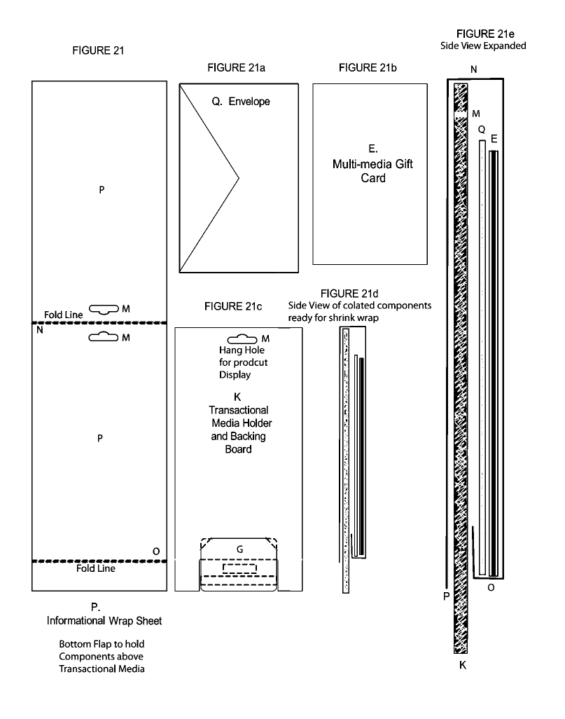

FIGS. 21-21e illustrate another embodiment of the present invention. FIG. 21 illustrates an informational wrap sheet that may be used to securely hold Total Gift Package components (that may comprise a Multimedia Gift Card and envelope) in place to allow easy access to transactional media. It is also used to display information regarding the Total Gift Package, its components, and any other information and indicia. FIG. 21b depicts a Multimedia Gift Card: A greeting card or folder that is designed and manufactured to hold digital and or transactional media. These additional components combined with the Multimedia Gift Card create the Total Gift Package. FIG. 21c illustrates a transactional media holder to allow access to transactional media without removing from secure packaging to include shrink wrap. FIG. 21d provides an illustration of a Total Gift Package for retail display side view, while FIG. 21e depicts an expanded side view of Total Gift Package for retail display.

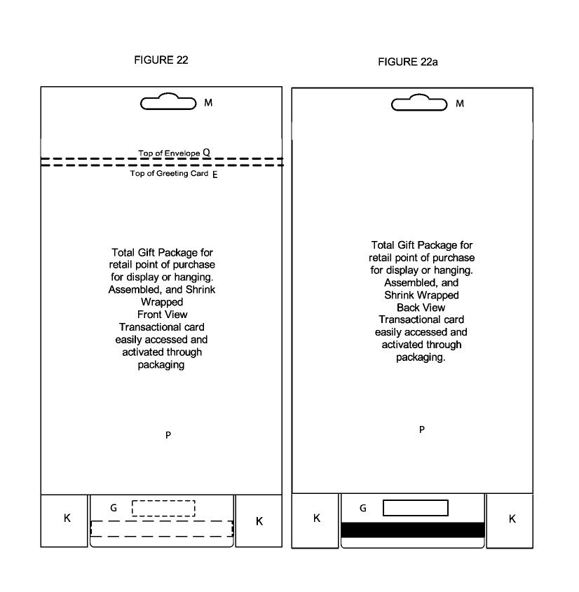

FIGS. 22-22a illustrate another embodiment of the present invention.

FIG. 22 is a front view of the Total Gift Package for retail point of purchase for display or hanging, while FIG. 22a depicts a back view of Total Gift Package for retail point of purchase for display or hanging.

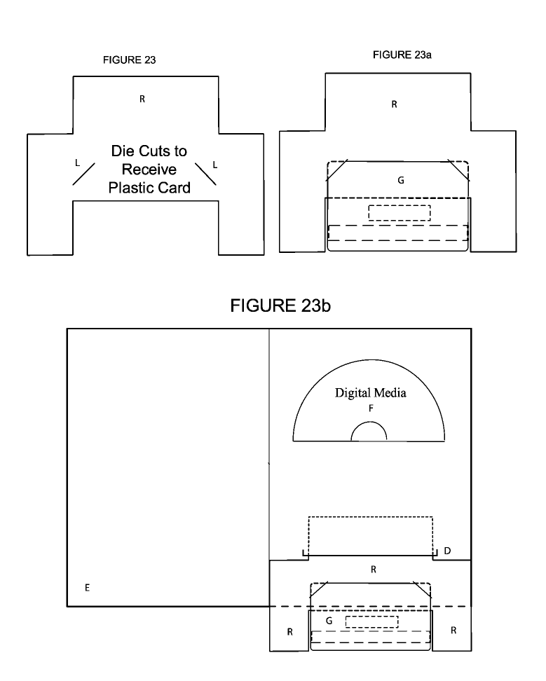

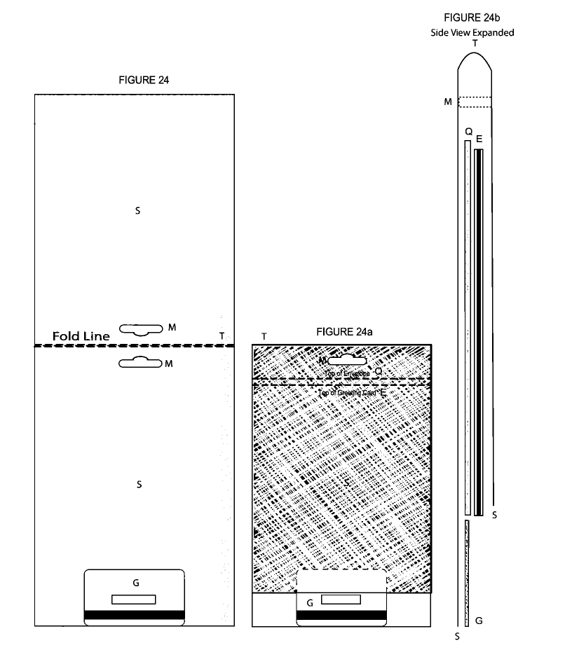

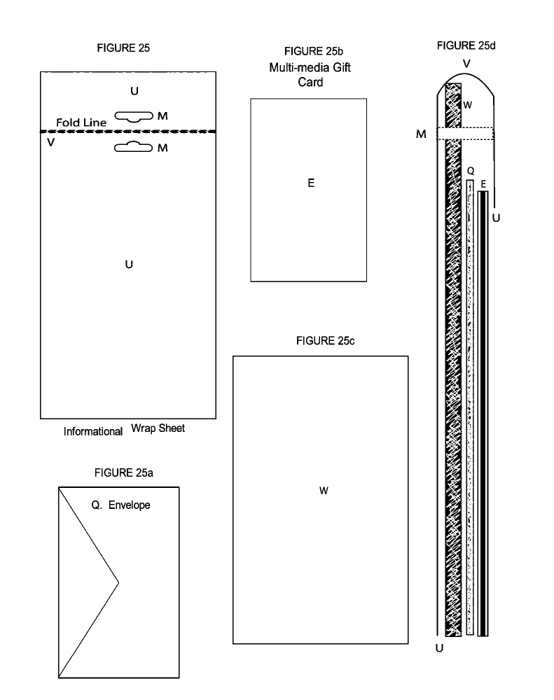

FIGS. 23-23b illustrate another embodiment of the present invention. FIGS. 23 and 23a depict a Transactional media holder that can be inserted into a die-cut holder and/or affixed with bonding agent to allow access to transactional media without removing it from its secure packaging, which may comprise shrink wrap. FIG. 23b depicts an example of how the Transactional media holder is attached to the Multimedia Gift Card either by inserting into die cut slot or by adhesive.

FIGS. 24-24b illustrate another embodiment of the present invention. This embodiment includes an Informational Wrap Sheet that is made from a more rigid material to include heavy weight paper or light weight card board. The Transactional media is attached by holders or a bonding agent.

FIG. 24a

Assembled Total Gift Package.

FIG. 24b

Expanded view of the assembled Total Gift Package.

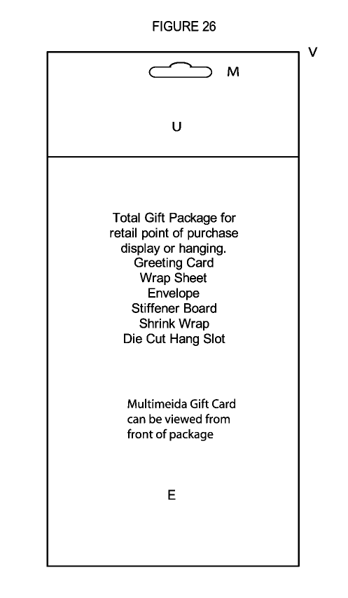

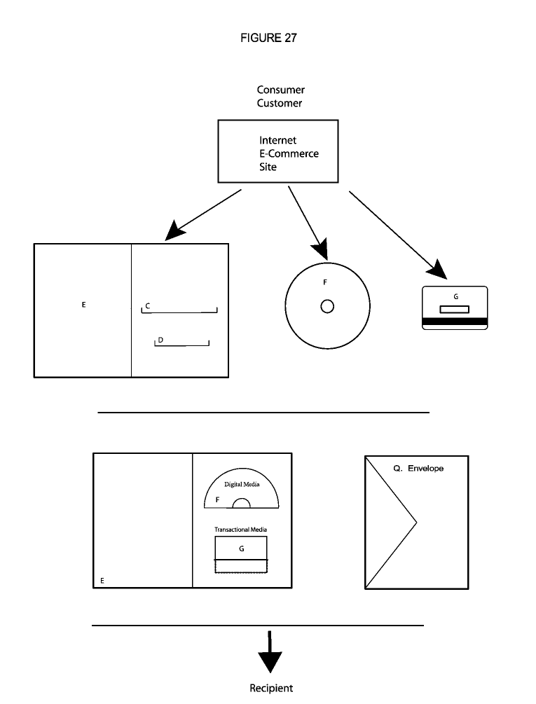

FIGS. 25-25d illustrate another embodiment of the present invention. FIG. 25 depicts an informational wrap sheet that allows the Multi-media Gift Card to be viewed through the front of the Total Gift Package. FIG. 25a illustrates an example of a Multimedia Gift Card envelope. FIG. 25b illustrates a Multimedia Gift Card that is designed and manufactured to hold digital and or transactional media. These additional components combined with the Multimedia Gift Card create the Total Gift Package. FIG. 25c depicts an expanded View of the assembled Total Gift Package. FIG. 25d depicts a side view of the various components as they are assembled in a final package.

FIG. 26 illustrates another embodiment of the present invention, namely the Total Gift Package for retail point of purchase display hanging with Multi-media Gift Card to be viewed through the front of the Gift Package.

FIG. 27 illustrates another embodiment of the present invention. The present invention also includes a process or method for an Internet ordering process for the Multi-media Gift Card and Total Gift Package. Via the internet, a greeting card is selected and personalized to include uploading and placing personal indicia on the digital media and greeting card. Digital media to include CD/DVD is chosen and customized by the client to include picking individual music selections to create a custom music compilation. Pre determined media can also be chosen to include Music CDs, DVD Movies and Audio Books. Transactional media can be chosen and customized to be included in the gift package. The components are packaged and shipped with an envelope to the specified recipient or to the client.

Although the present invention has been described with reference to particular embodiments, it will be apparent to those skilled in the art that variations and modifications can be substituted therefore without departing from the principles and spirit of the invention.

What is claimed is:

1. A total gift package comprising:
a multimedia gift card, wherein said multimedia gift card is configured to accept at least one media item.

2. The total gift package of claim 1 wherein said at least one media item further comprises a digital media item.

3. The total gift package of claim 1 wherein said at least one media item further comprises a transactional media item.

4. The total gift package of claim 1 wherein said multimedia gift card further comprises a media holding device.

5. The total gift package of claim 1 further wherein said at least one media item further comprises at least one digital media item and at least one transactional media item.

6. The total gift package of claim 5 wherein said multimedia gift card further comprises a digital media die cut and a transactional media die cut.

7. The total gift package of claim 5 wherein said multimedia gift card further comprises a digital media die cut and wherein said multimedia gift card further comprises an adhesive whereby said transactional media may be attached to said multimedia gift card.

8. The total gift package of claim 6 wherein said multimedia gift card further comprises a transactional media window.

9. The total gift package of claim 7 wherein said multimedia gift card further comprises a transactional media window.

10. The total gift package of claim 5 wherein said transactional media further comprises an integral portion of said multimedia gift card, and wherein said transactional media further comprises machine readable code.

11. The total gift package of claim 10 wherein said multimedia gift card further comprises a media holding device, and wherein said multimedia gift card further comprises a second transactional media item.

12. The total gift package of claim 5 wherein said transactional media item further comprises a detachable transactional media item.

13. The total gift package of claim 12 wherein said detachable transactional media item further comprises a perforated portion.

14. The total gift package of claim 13 wherein said perforated portion extends downwardly from said multimedia gift card.

15. A total gift package comprising:
a multimedia gift card;
an envelope corresponding to said multimedia gift card;
a transactional media holder backing board;
a transactional media item attached to said transactional media holder backing board; and
a wrap sheet enveloping said multimedia gift card, said envelope, said transactional media holder backing board and transactional media item, wherein said wrap sheet further comprises portions defining a mounting hole and wherein said wrap sheet further comprises a bottom flap, whereby said transactional media item extends below said envelope and said multimedia gift card.

16. A method for procuring a total gift package by means of the Internet, said method comprising the steps of:
designating a recipient;
creating total gift package components,
packaging said total gift package components to create a total gift package;
shipping said total gift package with an envelope to said recipient.

17. The method of claim 16, wherein said step of creating total gift package components further comprises the steps of:
selecting a greeting card;
personalizing the greeting card;
uploading personal indicia;
placing personal indicia on digital media;
placing personal indicia on the greeting card
creating a music compilation
choosing transactional media
customizing said transactional media.

18. The method of claim 17, wherein said step of creating a music compilation comprises creating a custom music compilation.

19. The method of claim 17, wherein said step of creating a music compilation comprises selecting an offered music compilation.
